(19) United States
(12) Patent Application Publication
(10) Pub. No.: US 2012/0155403 A1
(43) Pub. Date: Jun. 21, 2012

(54) TRANSMITTING AND RECEIVING APPARATUS AND CHANNEL COMPENSATION METHOD IN WIRELESS COMMUNICATION SYSTEM

(75) Inventor: Jun Hwan LEE, Seoul (KR)

(73) Assignee: Electronics and Telecommunications Research Institute, Daejeon (KR)

(21) Appl. No.: 13/331,035

(22) Filed: Dec. 20, 2011

(30) Foreign Application Priority Data
Dec. 21, 2010 (KR) 10-2010-0131457

(51) Int. Cl. H04L 25/08; H04W 74/04; H04W 72/04

(52) U.S. Cl. 370/329; 375/346

(57) ABSTRACT

Provided is transmitting and receiving apparatus and a channel compensation method in a wireless communication system based on Orthogonal Frequency Division Multiplexing (OFDM) in a wireless communication system. The receiving apparatus in the wireless communication system according to an embodiment of the present invention includes first and second estimators, an interference canceller, and a determination unit. The first estimator estimates an interference quantity detecting an interference in a received signal, the second estimator estimates a Signal-to-Noise Ratio (SNR) with the exception of a noise quantity corresponding to the estimated interference quantity. The interference canceller cancels the interference from the receiving signal. And a determination unit controls the operation of the interference canceller based on at least one of the estimated interference quantity and the estimated SNR.

### CROSS-REFERENCE TO RELATED APPLICATIONS

This U.S. non-provisional patent application claims priority under 35 U.S.C. §119 of Korean Patent Application No. 10-2010-0131457, filed on Dec. 21, 2010, the entire contents of which are hereby incorporated by reference.

### BACKGROUND OF THE INVENTION

The present invention disclosed herein relates to a transmitting and receiving apparatus and a channel compensation method in a wireless communication system, and more particularly, to a transmitting and receiving apparatus and a channel compensation method based on Orthogonal Frequency Division Multiplexing (OFDM) in a wireless communication system.

With the rapid development of the technology of wireless communication systems, a required data processing speed is also increasing. In order to meet this requirement, as a technology for high-speed data transmission, the research on an OFDM technique is actively being conducted. As a kind of multi-carrier transmission technology, the OFDM technique refers to the technique which multiplexes high-speed transmission signals using the plural sub-carriers which are orthogonal to each other. According to the OFDM technique, it is possible to increase frequency utilization efficiency by using sub-carriers which are orthogonal to each other in the time domain but are overlapped with each other in the frequency domain.

Meanwhile, in a wireless communication system, an interference due to changes of wireless channel environment results in degradation of communication quality. Especially, in a wireless communication system to which a multi-carrier transmission technique is applied, there are interferences resulting from the Doppler effect and the multi-path exceeding a guard interval.

### SUMMARY OF THE INVENTION

The present invention provides a transmitting and receiving apparatus and a channel compensation method for efficient control of packet delay and power consumption in a wireless communication system based on an OFDM technique.

Embodiments of the present invention provide receiving apparatuses in a wireless communication system including an estimator and an interference canceller. The estimator estimates an interference quantity by detecting an interference in a received signal, and estimates a Signal-to-Noise Ratio (SNR) with the exception of a noise quantity corresponding to the estimated interference quantity. The interference canceller cancels the interference from the receiving signal. The determination unit controls the operation of the interference canceller based on at least one of the estimated interference quantity and the estimated SNR.

In some embodiments, the receiving apparatus may further include a feedback information generation unit configured to generate feedback information including at least one of the estimated interference quantity, the estimated SNR, and an information of interference cancellation performance of the interference canceller.

In other embodiments, the receiving apparatus may further include a packet receiving verification unit configured to selectively output any one of an acknowledge response signal (ACK) and a non-acknowledge response signal (NACK) according to whether or not there is an error in the received signal.

In other embodiments of the present invention, transmitting apparatuses in a wireless communication system include a feedback information storage unit and a packet retransmission scheduler. The feedback information storage unit stores feedback information including at least one of an interference quantity estimated at a receiving apparatus, a Signal-to-Noise Ratio (SNR) with the exception of a noise quantity corresponding to the estimated interference quantity, and information about an interference cancellation performance of the receiving apparatus. The packet retransmission scheduler schedules a packet retransmission operation on the basis of a response signal on whether or not the receiving apparatus has received a packet, and the feedback information.

In still other embodiments, the packet retransmission scheduler may schedule to stop the packet retransmission operation when the estimated interference quantity is equal to or smaller than a reference interference quantity corresponding to the interference cancellation performance even though a non-acknowledge response signal (NACK) on whether or not the receiving apparatus has received the packet is received.

In still other embodiments of the present invention, channel compensation methods in a wireless communication system include estimating an interference quantity of a wireless channel; selectively performing an interference cancellation operation on the basis of the estimated interference quantity and an information of interference cancellation performance; generating feedback information including the estimated interference quantity and the information of interference cancellation performance; generating a response signal on whether or not there is an error in packets received through the wireless channel; and scheduling a packet retransmission operation based on the response signal and the feedback information.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram briefly illustrating a wireless communication system according to one embodiment of the present invention;

FIG. 2 is a block diagram illustrating a portion of a receiving apparatus according to one embodiment of the present invention; and

FIG. 3 is a flowchart illustrating a channel compensation method in a wireless communication system according to an embodiment of the present invention.

### DETAILED DESCRIPTION OF PREFERRED EMBODIMENTS

Hereinafter, embodiments of the present invention will be described in detail with reference to the accompanying drawings in such a manner that the technical idea of the present invention may easily be carried out by a person with ordinary skill in the art to which the invention pertains. The present invention may, however, be embodied in different forms and should not be constructed as limited to the embodiments set forth herein. And in the drawings, parts unrelated to the description of the present invention will be omitted for clarity in description, and like parts will be designated by like reference numerals throughout.

Meanwhile, in this disclosure below, when one part is referred to as being “connected” to another part, it should be understood that the former can be “directly connected” to the latter, or “electrically connected” to the latter via an intervening part. Furthermore, when it is described that one comprises (or includes or has) some elements, it should be understood that it may comprise (or include or has) only those elements, or it may comprise (or include or have) other elements as well as those elements if there is no specific limitation.

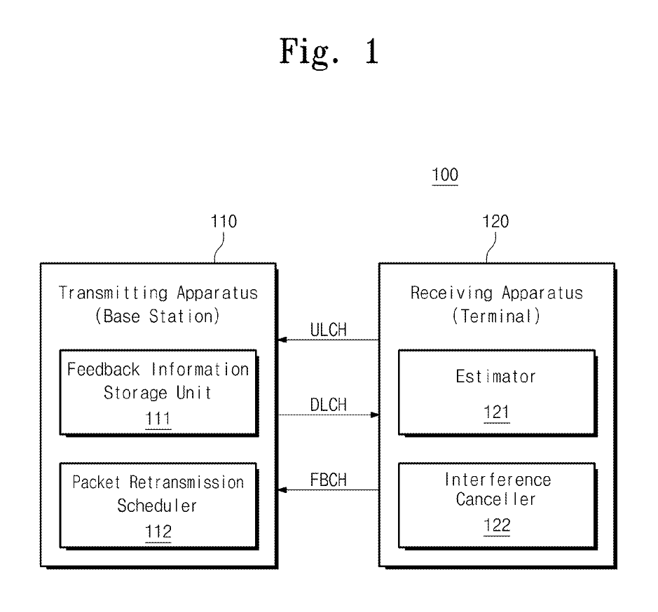

FIG. 1 is a block diagram briefly showing a wireless communication system 100 according to one embodiment of the present invention. Hereinafter, as one embodiment of the present invention, the wireless communication system 100 based on Orthogonal Frequency Division Multiplexing (OFDM) will be explained.

Referring to FIG. 1, the wireless communication system 100 includes a transmitting apparatus 110 and a receiving apparatus 120 which communicate through such various channels as Uplink Channel (ULCH), Downlink Channel (DLCH), Feedback Channel (FBCH), or the like.

Even though not illustrated in the drawings, the transmitting apparatus 110 includes such elements as an encoder, a modulator, a serial-to-parallel converter, a sub-channel allocator, an Inverse Fast Fourier Transform (IFFT) calculator, a parallel-to-serial converter, a guard interval inserter, a digital-to-analog converter, a Radio Frequency (RF) transmitting processor, or the like.

Also, in one embodiment of the present invention, the transmitting apparatus 110 includes a feedback information storage unit 111 and a packet retransmission scheduler 112 as elements supporting Hybrid Automatic Retransmission reQuest (hereinafter referred to as “HARQ”).

The encoder encodes input data using a pre-defined encoding technique.

The modulator generates symbols by modulating the encoded data which are outputted from the encoder using a pre-defined modulation technique. For example, such modulation techniques as Phase Shift Keying (PSK), Quadrature Phase Shift Keying (QPS), Binary Phase Shift Keying (BPSK), Quadrature Amplitude Modulation (QAM), or the like may be used.

The serial-to-parallel converter converts serial modulated symbols outputted from the modulator into parallel modulated symbols.

The sub-channel allocator allocates parallel modulated symbols outputted from the serial-to-parallel converter to plural sub-carriers.

The Inverse Fast Fourier Transform (IFFT) calculator generates parallel OFDM symbols by performing IFFT calculation on the parallel modulated symbols which are outputted from the sub-channel allocator.

The parallel-to-serial converter converts the parallel OFDM symbols which are outputted from the IFFT converter into serial OFDM symbols.

The guard interval inserter inserts a guard interval between the serial OFDM symbols which are outputted from the parallel-to-serial converter. Then, the guard interval inserter may insert a guard interval using either a cyclic prefix technique or a cyclic postfix technique.

The digital-to-analog converter converts a digital signal which is outputted from the guard interval inserter into an analog signal.

The RF transmitting processor performs an operation for transmitting a signal outputted from the digital-to-analog converter through a wireless channel.

The feedback information storage unit 111 stores feedback information which is transmitted through a dedicated Feedback Channel (FBCH) from the receiving apparatus 120. In one embodiment of the present invention, the feedback information includes at least one of an interference quantity and a Signal-to-Noise Ratio which are estimated at the receiving apparatus 120, and information about an interference cancellation performance of the receiving apparatus 120. Herein, the Signal-to-Noise Ratio is calculated with the exception of a noise quantity corresponding to the interference quantity estimated at the receiving apparatus 120.

The packet retransmission scheduler 112 schedules a packet retransmission operation on the basis of a response signal on whether or not the receiving apparatus 120 has received a packet and the feedback information stored in the feedback information storage unit 111. This operation means that the transmitting apparatus 110 schedules the packet retransmission operation in the view of the interference quantity, the Signal-to-Noise Ratio, the interference cancellation performance, or the like of the receiving apparatus 120.

If an acknowledge response signal (ACK) on whether or not the receiving apparatus 120 has received the packet is received, the packet retransmission scheduler 112 stops the packet retransmission operation. And if a non-acknowledge response signal (NACK) on whether or not the receiving apparatus 120 has received the packet is received, the packet retransmission scheduler 112 determines whether or not a packet retransmission operation should be performed, on the basis of feedback information

For example, even though the non-acknowledge response signal (NACK) on whether or not the receiving apparatus 120 has received the packet is received, if the estimated interference quantity is equal to or smaller than a reference interference quantity corresponding to the interference cancellation performance, the packet retransmission scheduler 112 schedules so that the packet retransmission operation may be stopped. Alternatively, if the Signal-to-Noise Ratio is equal to or greater than a reference Signal-to-Noise Ratio corresponding to the interference cancellation performance, the packet retransmission scheduler 112 schedules so that the packet retransmission operation may be stopped.

The receiving apparatus includes an estimator 121 and an interference canceller 122.

The estimator 121 estimates an interference quantity detecting an interference in a received signal. In this operation, the estimator 121 may detect the interference using a pilot signal. Also, the estimator 121 estimates a Signal-to-Noise Ratio from which a noise quantity corresponding to the estimated interference quantity is excepted.

The interference canceller 122 performs an interference cancellation operation by a pre-defined interference cancellation algorithm. In this operation, whether or not the interference canceller 122 should be operated is determined on the basis of at least one of the interference quantity and the Signal-to-Noise Ratio which is estimated by the estimator 121.

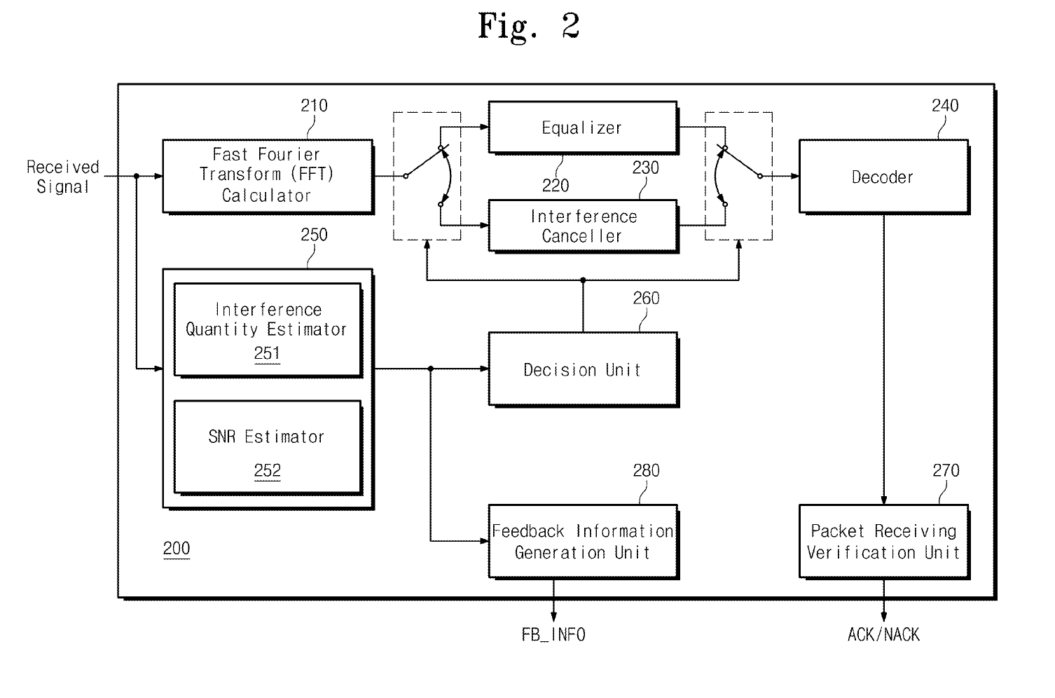

The receiving apparatus 120 generates the feedback information including the estimated interference quantity, the estimated Signal-to-Noise Ratio and information about an interference cancellation performance of the interference canceller 122, and then transmits the feedback information to the transmitting apparatus 110. As describe above, the feedback information is used to schedule the packet retransmission operation. The receiving apparatus 120 will be described in more detail with reference to FIG. 2 below.

As describe above, the wireless communication system 100 according to one embodiment of the present invention applies all of a HARQ technique and an interference cancellation technique. However, when applying the HARQ technique, there is a time delay due to packet retransmission. When applying the interference cancellation technique, there is a limitation in power consumption due to a computational processing of an interference cancellation algorithm. In order to reduce the time delay and the power consumption, an efficient management in a HARQ operation and the interference cancellation operation is required.

For the sake of this, in the wireless communication system 100 according to one embodiment of the present invention, the receiving apparatus 100 estimates an interference quantity of a wireless channel, and then selectively performs the interference cancellation operation on the basis of the estimated interference quantity. And the receiving apparatus 100 transmits the feedback information including the estimated interference quantity and the information about the interference cancellation performance to the transmitting apparatus 110 through the dedicated feedback channel (FBCH). The transmitting apparatus 110 schedules the HARQ operation on the basis of the feedback information transmitted through the dedicated feedback channel (FBCH). It means that HARQ scheduling of the transmitting apparatus 110 and power control of the receiving apparatus 120 are performed in the view of Quality of Service (QoS) in respect of each user.

FIG. 2 is a block diagram showing a portion of a receiving apparatus 200 according to one embodiment of the present invention. Referring to FIG. 2, the receiving apparatus 200 includes a Fast Fourier Transform (FFT) calculator 210, an equalizer 220, an interference canceller 230, a decoder 240, an estimator 250, a determination unit 260, a packet receiving verification unit 270, and a feedback information generation unit 280.

Also, even though not illustrated in the drawings, the receiving apparatus 200 includes such elements as a Radio Frequency (RF) receiving processor, an analog-to-digital converter, a demodulator, or the like. Detailed descriptions of these will be omitted.

The FFT calculator 210 generates modulated symbols by performing a FFT calculation on OFDM symbols which are within a received signal.

The equalizer 220 performs an equalization operation on signals outputted from the FFT calculator 210 by using a pre-defined equalization algorithm.

The interference canceller 230 eliminates an interference component from a signal outputted from the FFT calculator 210 by using a pre-defined interference cancellation algorithm.

The decoder 240 decodes data corresponding to a signal outputted from any one of the equalizer 220 and the interference canceller 230 by using a pre-defined decoding technique.

The estimator 250 includes an interference quantity estimator 251 and a SNR estimator 252.

The interference quantity estimator 251 detects Inter-Symbol Interference (hereinafter referred to as “ISI”) and Inter-sub-Carrier Interference (herein after referred to as “ICI”) in the received signal, and then estimates the interference quantity. Herein, ISI and ICI result from such causes as channel environments having multi-path, frequency disparity between a transmitting apparatus and a receiving apparatus, or the like.

Interference quantities of ISI and ICI may exemplarily be computed using Equations (1) and (2) below:

$$\begin{matrix}{P}_{ISI} = {\sum }_{l = 0}^{L - 1} ( \frac{{τ}_{l} - G}{N} ) E [ {\vert {α}_{l} \vert}^{2} ] & ( 1 ) \\ {P}_{ICI} = {\sum }_{l = 0}^{L - 1} ( \frac{{τ}_{l} - G}{N} ) ( \frac{N + G - {τ}_{l}}{N} ) E [ {\vert {α}_{l} \vert}^{2} ] & ( 2 )\end{matrix}$$

where N denotes a size of FFT calculation, G represents a length of a guard interval, τ₁ denotes a delay time due to multi-path, and α₁ represents a wireless channel coefficient.

In Equations (1) and (2), when assuming a size N of FFT calculation is much greater than the delay time τ₁ due to multi-path, interference quantities of ISI and ICI are the same, and accordingly a total interference quantity P_{TOT} may be expressed as 2P_{ISI} or 2P_{ICI}.

The SNR estimator 252 estimates the Signal-to-Noise Ratio from which the noise quantity corresponding to the estimated interference quantity is excepted.

The estimator 250 provides estimation results of the interference quantity and the Signal-to-Noise Ratio for the determination unit 260 and the feedback information generation unit 280.

On the basis of at least one of the interference quantity and the Signal-to-Noise Ratio which are estimated, the determination unit 260 controls whether or not the equalizer 220 and the interference canceller 230 should be operated. That is, the equalizer 220 and the interference canceller 230 may selectively be operated in response to the control of the determination unit 260.

For example, if the estimated interference quantity is equal to or smaller than a reference interference quantity, the interference cancellation operation of the interference canceller 230 is performed in lieu of the equalization operation of the equalizer 220. If the estimated interference quantity is greater than the reference interference quantity, the equalization operation of the equalizer 220 is performed in lieu of the interference cancellation operation of the interference canceller 230.

Alternatively, if the estimated Signal-to-Noise Ratio is equal to or greater than a reference Signal-to-Noise Ratio, the interference cancellation operation of the interference canceller 230 is performed in lieu of the equalization operation of the equalizer 220. If the estimated Signal-to-Noise Ratio is smaller than the reference Signal-to-Noise Ratio, the equalization operation of the equalizer 220 is performed in lieu of the interference cancellation operation of the interference canceller 230.

The reference interference quantity and the reference Signal-to-Noise Ratio which are described above correspond to the interference cancellation performance of the interference canceller 230.

The packet receiving verification unit 270 verifies whether or not there is any packet error in the received signal by the HARQ algorithm. For the sake of this, the packet receiving verification unit 270 verifies whether or not there is any packet error in a signal outputted from the decoder 240. If no packet error occurs, the packet receiving verification unit 270 outputs the acknowledge response signal (ACK). If a packet error occurs, the packet receiving verification unit 270 outputs the non-acknowledge response signal (NACK).

The feedback information generation unit 280 generates the feedback information (FB_INFO) including at least one of the interference quantity and the Signal-to-Noise Ratio which are estimated, and the information about the interference cancellation performance of the interference canceller 230. The feedback information (FB_INFO) is transmitted the transmitting apparatus 110 (see FIG. 1) through the dedicated feedback channel.

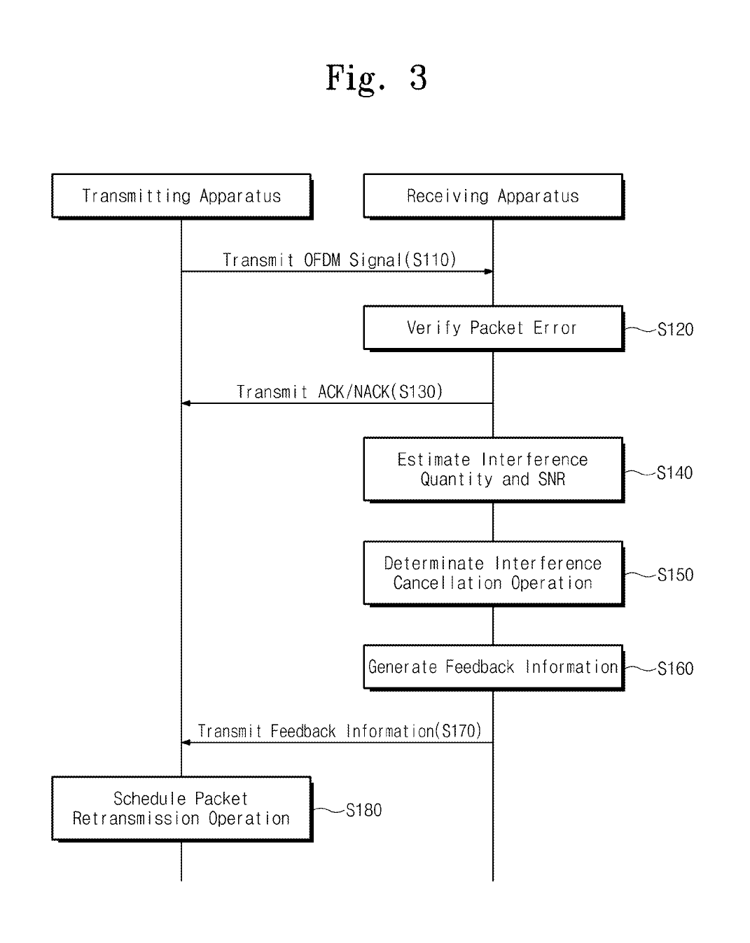

FIG. 3 is a flowchart for explaining a channel compensation method in a wireless communication system according to one embodiment of the present invention.

Referring to FIG. 3, in operation 5110, an OFDM signal is transmitted to the receiving apparatus 120 from the transmitting apparatus 110. Herein, a packet within the OFDM signal may be lost or modified due to channel environment.

In operation S120, the HARQ algorithm verifies whether or not there is any error in a packet received through a wireless channel.

In operation S130, according to a packet error verification result, any one of the acknowledge response signal (ACK) and the non-acknowledge response signal (NACK) is transmitted to the transmitting apparatus 110 from the receiving apparatus 120.

In operation S140, Interference quantities of ISI and ICI due to the wireless channel are estimated. And the Signal-to-Noise Ratio with the exception of the noise quantity corresponding to the estimated interference quantity is estimated.

In operation S150, it is estimated whether or not the interference cancellation operation for channel compensation should be performed. For example, the interference cancellation operation is selectively performed on the basis of the estimated interference quantity and the information about the interference cancellation performance. Alternatively, the interference cancellation operation is selectively performed on the basis of the estimated Signal-to-Noise Ratio and the information about the interference cancellation performance.

In operation S160, the feedback information including at least one of the interference quantity and the Signal-to-Noise Ratio which are estimated, and the information about the interference cancellation performance is generated.

In operation S170, the feedback information is transmitted to the transmitting apparatus 110 from the receiving apparatus 120 through the dedicated Feedback Channel.

In operation S180, the packet retransmission operation by the HARQ algorithm is scheduled on the basis of a response signal according to packet error verification result and the feedback information transmitted through the dedicated Feedback Channel.

The operations S110-S180 described above may periodically be performed.

As described above, according to the present invention, it is possible to reduce a packet receiving delay due to a packet retransmission and power consumption due to an interference cancellation operation by controlling a packet retransmission by the HARQ technique and the interference cancellation operation on the basis of estimated interference quantity.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A receiving apparatus in a wireless communication system, comprising:
an estimator estimating an interference quantity through detection of an interference in a received signal, and estimating a Signal-to-Noise Ratio (SNR) with the exception of a noise quantity corresponding to the estimated interference quantity;
an interference canceller cancelling the interference from the receiving signal; and
a determination unit controlling an operation of the interference canceller based on at least one of the estimated interference quantity and the estimated SNR.

2. The receiving apparatus of claim 1, further comprising a feedback information generation unit configured to generate feedback information including at least one of the estimated interference quantity, the estimated SNR, and an information of interference cancellation performance of the interference canceller.

3. The receiving apparatus of claim 1, wherein the determination unit controls the operation of the interference canceller according to a comparison result between the estimated interference quantity and a reference interference quantity corresponding to an interference cancellation performance of the interference canceller.

4. The receiving apparatus of claim 3, wherein the interference canceller performs an interference cancellation operation when the estimated interference quantity is equal to or smaller than the reference interference quantity, and stops the interference cancellation operation when the estimated interference quantity is greater than the reference interference quantity.

5. The receiving apparatus of claim 1, wherein the determination unit controls the operation of the interference canceller according to a comparison result between the estimated SNR and a reference SNR corresponding to an interference cancellation performance of the interference canceller.

6. The receiving apparatus of claim 5, wherein the interference canceller performs an interference cancellation operation when the estimated SNR is equal to or greater than the reference SNR, and stops the interference cancellation operation when the estimated SNR is smaller than the reference SNR.

7. The receiving apparatus of claim 1, further comprising a packet receiving verification unit configured to selectively output any one of an acknowledge response signal (ACK) and a non-acknowledge response signal (NACK) according to whether or not there is an error in at least one of packet of the received signal.

8. The receiving apparatus of claim 7, wherein the packet receiving verification unit is operated by a Hybrid Automatic Retransmission reQuest (HARQ) algorithm.

9. A transmitting apparatus in a wireless communication system, comprising:
a feedback information storage unit storing feedback information including at least one of an interference quantity estimated at a receiving apparatus, a Signal-to-Noise Ratio (SNR) with the exception of a noise quantity corresponding to the estimated interference quantity, and information about an interference cancellation performance of the receiving apparatus; and
a packet retransmission scheduler scheduling a packet retransmission operation on the basis of a response signal on whether or not the receiving apparatus has received a packet, and the feedback information.

10. The transmitting apparatus of claim 9, wherein the packet retransmission scheduler schedules to stop the packet retransmission operation when the estimated interference quantity is equal to or smaller than a reference interference quantity corresponding to the interference cancellation performance even though a non-acknowledge response signal (NACK) is received,
Wherein the non-acknowledge response signal (NACK) represent whether or not the receiving apparatus has received the packet.

11. The transmitting apparatus of claim 9, wherein the packet retransmission scheduler schedules to stop the packet retransmission operation when the SNR is equal to or greater than a reference SNR corresponding to the interference cancellation performance even though a non-acknowledge response signal (NACK) is received
Wherein the non-acknowledge response signal (NACK) represent whether or not the receiving apparatus has received the packet.

12. The transmitting apparatus of claim 9, wherein the feedback information is transmitted through a dedicated Feedback Channel from the receiving apparatus.

13. A channel compensation method in a wireless communication system, the method comprising:
estimating an interference quantity of a wireless channel;
selectively performing an interference cancellating operation based on the estimated interference quantity and an information of interference cancellation performance;
generating feedback information including the estimated interference quantity and the information of interference cancellation performance;
generating a response signal on whether or not there is an error in packets received through the wireless channel; and
scheduling a packet retransmission operation based on the response signal and the feedback information.

14. The channel compensation method of claim 13, wherein the estimating of the interference quantity comprises estimating the interference quantity of Inter-Symbol Interference (ISI) and Inter-Carrier Interference (ICI).

15. The channel compensation method of claim 13, further comprising estimating an (Signal-to-Noise Ratio) SNR with the exception of a noise quantity corresponding to the estimated interference quantity.

16. The channel compensation method of claim 15, wherein the feedback information further comprises the estimated SNR.
